(19) United States
(12) Patent Application Publication
(10) Pub. No.: US 2013/0038982 A1
(43) Pub. Date: Feb. 14, 2013

(54) MULTILAYER CERAMIC CONDENSER AND METHOD FOR MANUFACTURING THE SAME

(71) Applicants: Kwang Jik Lee, Gyeonggi-do (KR); Suk Jin Ham, Seoul (KR); Ji Hyuk Lim, Gyeonggi-do (KR)

(72) Inventors: Kwang Jik Lee, Gyeonggi-do (KR); Suk Jin Ham, Seoul (KR); Ji Hyuk Lim, Gyeonggi-do (KR)

(21) Appl. No.: 13/413,574

(22) Filed: Mar. 6, 2012

(30) Foreign Application Priority Data
Aug. 12, 2011 (KR) 10-2011-0080761

(51) Int. Cl. H01G 4/005; B05D 1/18; B05D 3/12; B05D 5/12

(52) U.S. Cl. 361/303; 427/79

(57) ABSTRACT

Disclosed herein are a multilayer ceramic condenser and a method for manufacturing the same. The multilayer ceramic condenser includes inner metal electrode layers formed within a magnetic layer, and conductive layers each formed between the inner metal electrode layers, and a method for manufacturing the same.

According to the present invention, a contact between the inner metal electrode layers in the multilayer ceramic condenser can be prevented, thereby reducing the manufacturing loss due to occurrence of short circuits and improving thermal stability, by forming an ultrathin conducting layer with a thickness of about 10 nm or less between the inner metal electrode layers. Therefore, the multilayer ceramic condenser can be ensured to have excellent reliability to meet the demands of markets requesting a high-capacity multilayer ceramic condenser (MLCC) having high performance, small size, and light weight.

### CROSS REFERENCE(S) TO RELATED APPLICATIONS

This application claims the benefit under 35 U.S.C. Section 119 of Korean Patent Application Serial No. 10-2011-0080761, entitled “Multilayer Ceramic Condenser and Method for Manufacturing the Same” filed on Aug. 12, 2011, which is hereby incorporated by reference in its entirety into this application.

### BACKGROUND OF THE INVENTION

1. Technical Field

The present invention relates to a multilayer ceramic condenser and a method for manufacturing the same.

2. Description of the Related Art

With the increase in the demand for a high-capacity multilayer ceramic condenser (MLCC) according to the tendency for high performance, small size, and light weight of electronic products, studies on the MLCC have also been actively progressing. However, a structure between a ceramic dielectric and an inner metal electrode layer needs to be efficiently designed by new techniques, in order to meet the expectations of market demands that require an MLCC to have a larger capacitance.

Efforts continue to increase the area of an interface between an inner electrode and a dielectric to the maximum and decrease a distance between inner electrodes. However, as the distance between the inner electrodes becomes reduced, the inner electrodes are short-circuited during a processing procedure, resulting in more defective products. Therefore, measures against this problem are being requested.

FIG. 1 shows a structure of a general MLCC and images obtained by measuring cross sections of different MLCCs using a field emission-scanning electron microscope (FE-SEM). Referring to FIG. 1, a general MLCC has a structure in which a plurality of inner metal electrode layers 20 each are laminated between dielectric ceramics (dielectric layer 10). An MLCC consisting of dielectric layers 10 each having a thickness of 0.6 m and inner metal electrode layers 20 each having a thickness of 0.5 μm is shown in (a) of FIG. 1, and another MLCC consisting of dielectric layers 10 and inner metal electrode layers 20 each having a thickness of 0.6 μm.

In the MLCCs having the above structures, when a distance between the inner electrodes becomes reduced, there occurs a defect problem in that the inner metal electrodes are short-circuited to each other during a processing procedure, as shown in FIG. 2 (see, a circle part). FIG. 3 shows an enlarged view of the circle part of FIG. 2. It can be confirmed from FIG. 3 that the inner electrode layers are short-circuited to each other.

So far, many-sided efforts are continuing in order to prevent a short defect of the MLCC. A main approach in these efforts is to reduce surface roughness of the inner metal electrode layer and the dielectric layer.

In other words, contact between two metal layers is prevented by forming a smoother and uniform film. To achieve this, ceramic or metal powder used as raw materials of respective layers needs to be smaller-sized and more uniform, and coating methods for a uniform thin film need to be developed.

### SUMMARY OF THE INVENTION

An object of the present invention is to provide a multilayer ceramic condenser with a new structure capable of solving a short defect between inner metal electrode layers in an MLCC of the related art.

Another object of the present invention is to provide a method for manufacturing the multilayer ceramic condenser with the new structure.

According to an exemplary embodiment of the present invention, there is provided a multilayer ceramic condenser, including conducting layers each formed between inner metal electrode layers formed within a magnetic layer, and thereby solving a short defect between the inner metal electrode layers.

The conducting layer may have a fine thickness of 10 nm or less.

The conducting layer may be disposed above, below, or both above and below the inner metal electrode layer.

The conducting layer may be formed of a material that is maintainable at a high-temperature sintering temperature of 900 to 1100° C.

The material may be graphene.

According to an exemplary embodiment of the present invention, there is provided a method for manufacturing a multilayer ceramic condenser, including: forming inner metal electrode layers within a magnetic layer; and forming conducting layers each between the inner metal electrode layers

The conducting layer may be formed to have a fine thickness of 10 nm or less.

The conducting layer may be formed by a film transfer method, a dipping method, or a spin coating method.

### BRIEF DESCRIPTION OF THE DRAWINGS

FIG. 1 shows a structure of a general MLCC and photographs obtained by measuring cross sections of different MLCCs using a field emission-scanning electron microscope (FE-SEM), and here, (a) of FIG. 1 shows a structure of an MLCC consisting of dielectric layers 10 each having a thickness of 0.6 μm and inner metal electrode layers 20 each having a thickness of 0.5 μm and (b) of FIG. 1 shows a structure of another MLCC consisting of dielectric layers and inner metal electrode layers 20 each having a thickness of 0.6 μm;

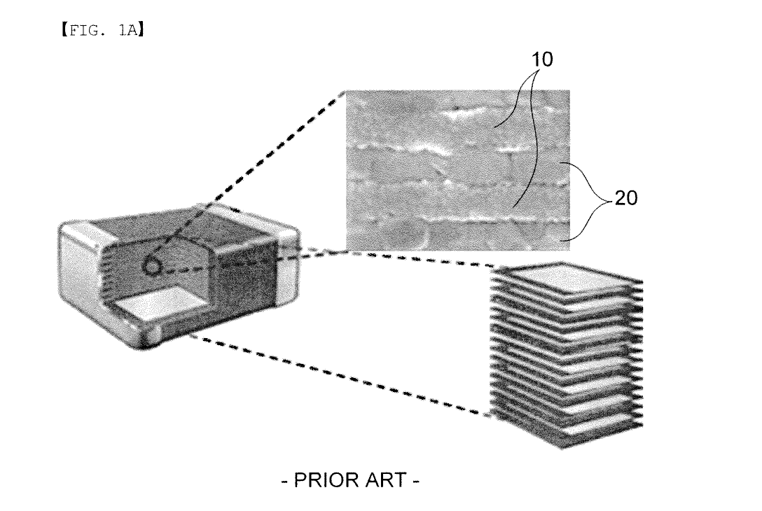

FIGS. 2 and 3 are field emission-scanning electron microscope (FE-SEM) photographs showing a connection defect between inner electrodes in the related art; and

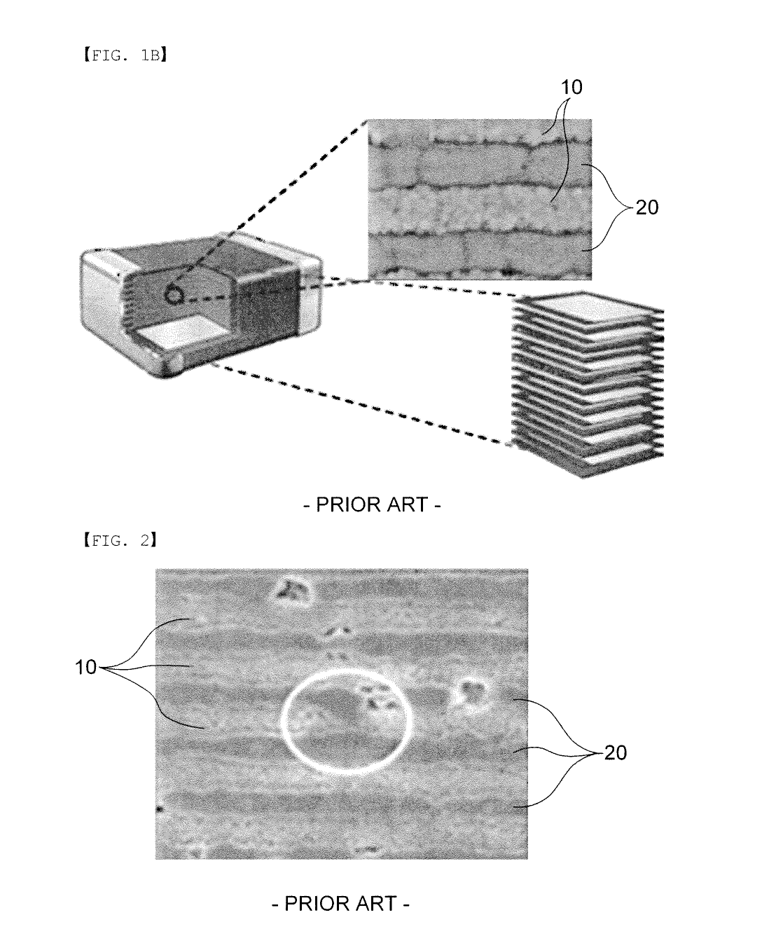

FIG. 4 shows a structure of a multilayer ceramic condenser including a conducting layer according to an exemplary embodiment of the present invention.

### DESCRIPTION OF THE PREFERRED EMBODIMENTS

Hereinafter, the present invention will be described in more detail.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention is directed to a multilayer ceramic condenser with a new structure capable of removing a short defect between inner metal electrode layers, and a method for manufacturing the same.

An object of the present invention is to prevent a contact between inner metal electrode layers by forming an ultrathin conducting layer with a thickness of several nanometers between the inner metal electrode layers, unlike the approach used in the MLCC of the related art.

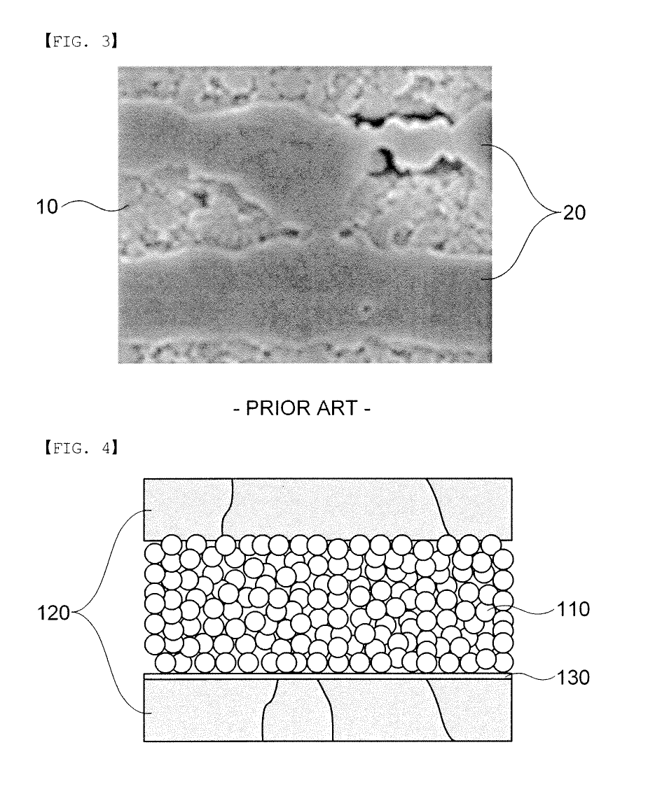

FIG. 4 shows a structure of an MLCC according to an exemplary embodiment of the present invention. The MLCC includes inner metal electrode layers 120 stacked with each dielectric layer 110 therebetween, and, particularly, a conducting layer 130 having a fine thickness between the stacked inner metal electrode layers 120.

Generally, when the MLCC becomes thickened by including separate layers in a structure thereof, a capacitance (dielectric constant) thereof may be dropped. Therefore, in the present invention, the conducting layer 130 is formed to have a fine thickness of about 10 nm or less, and thus, a drop ratio of capacitance due to increase in thickness falls within an error range.

In the present invention, the conducting layer 130 is stacked within the dielectric layer 110, and formed to achieve the insulation between adjacent inner metal electrode layers 120. Therefore, the conducting layer 130 may be included above, below, or both above and below the inner metal electrode layer 120. A position of the conducting layer 130 is not particularly limited, but may be appropriately selected within the range where the inner metal electrode layers can be insulated from each other and the capacity of the MLCC can not be dropped.

Considering that the MLCC is sintered at a high temperature of about 900° C. or higher, a material that can be maintained at a high-temperature sintering temperature of about 900° C. or higher, and preferably, 900 to 1100° C., may be used for the conducting layer 130 of the present invention.

An example of this material may be most preferably graphene.

Since the graphene has the same lateral strength as diamond, nickel nanoparticles used for the inner metal electrode layer can not penetrate into the graphene and nor protrude when the graphene is positioned between the inner metal electrode layer and the dielectric layer 2. As a result, this graphene can prevent a short defect from occurring when the inner metal electrode layers are contacted with each other.

That is to say, the conducting layer made of graphene can prevent a nickel (Ni) nanoparticle paste used for the inner metal electrode layer from protruding into pores between ceramic particles of the dielectric ceramic layer.

In addition, this introduction of graphene can prevent insulating resistance (IR) of the MLCC from being deteriorated. The particles of the inner metal electrode layer irregularly protrude at an interface between the inner metal electrode layer and the dielectric layer in the current MLCC. Therefore, an electric field inside the MLCC device is concentrated at this portion, causing deterioration, and resulting in reduction of IR.

However, when the conducting layer using graphene is introduced like in the present invention, the interface between the inner metal electrode layer and the dielectric layer can be more uniformly and flatly controlled, thereby preventing concentration of deterioration, resulting in improved thermal stability.

Therefore, the multilayer ceramic condenser including the conducting layer using grapheme, like in the present invention, can solve the short defect problems due to contact between the inner metal electrode layers because the inner metal electrode layers can not penetrate into each other, and can have excellent effects in property at high temperature.

A method for manufacturing an MLCC according to the present invention is as follows. First, inner metal electrode layers are formed within a magnetic layer.

The magnetic layer according to the present invention is made by mixing several additives into NiZnCu ferrite, and a specific composition thereof is not particularly limited.

The inner metal electrode layer formed within the magnetic layer may be formed by using at least one metal selected from the group consisting of Ag, Sn, Ni, Pt, Au, Cu, and an alloy thereof, and among them, Ag or Cu may be preferably used.

Then, a conducting layer is formed between the inner metal electrode layers. The conducting layer is preferably formed to have a fine thickness of 10 nm or less.

The conducting layer of the present invention may be formed by using graphene. A thickness of one layer of graphene is only 0.5 nm, and thus, one layer of graphene allows a conducting layer to be formed with a fine thickness.

The conducting layer having a fine thickness may be formed by a film transfer method, a spin coating method, or a dipping method. Among them, the film transfer method is more preferable, but not particularly limited.

As described above, the conducting layer is included between the inner metal electrode layers formed within the magnetic layer and thus, prevents contact between the inner metal electrode layers, which easily occurs during a compressing procedure or a sintering procedure in the MLCC, thereby reducing the defective ratio due to short circuits.

According to the present invention, the contact between inner metal electrode layers can be prevented in a multilayer ceramic condenser (MLCC), by forming an ultrathin conducting layer of 10 nm or less between inner metal electrode layers, thereby reducing the manufacturing loss due to an occurrence of a short circuit. Therefore, a multilayer ceramic condenser can be ensured to have excellent reliability to meet the demands of markets requesting a high-capacity multilayer ceramic condenser (MLCC) having high performance, small size, and light weight.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic condenser, comprising:
inner metal electrode layers formed within a magnetic layer; and
conducting layers each formed between the inner metal electrode layers.

2. The multilayer ceramic condenser according to claim 1, wherein the conducting layer has a fine thickness of 10 nm or less.

3. The multilayer ceramic condenser according to claim 1, wherein the conducting layer is disposed above, below, or both above and below the inner metal electrode layer.

4. The multilayer ceramic condenser according to claim 1, wherein the conducting layer is formed of a material that is maintainable at a high-temperature sintering temperature of 900 to 1100° C.

5. The multilayer ceramic condenser according to claim 4, wherein the material is graphene.

6. A method for manufacturing a multilayer ceramic condenser, comprising:
forming inner metal electrode layers within a magnetic layer; and
forming conducting layers each between the inner metal electrode layers.

7. The method according to claim 6, wherein the conducting layer is formed to have a fine thickness of 10 nm or less.

8. The method according to claim 6, wherein the conducting layer is formed by one method selected from a film transfer method, a dipping method, and a spin coating method.
